(19) United States
(12) Patent Application Publication
(10) Pub. No.: US 2006/0122026 A1
(43) Pub. Date: Jun. 8, 2006

(54) Shiftable drive mechanism for a bicycle or the like

(76) Inventor: Florian Schlumpf, Vilters (CH)

Correspondence Address: Ursula B. Day;Henry M. Feiereisen, LLC, Suite 4714, 350 Fifth Avenue, New York, NY, 10118, US

(21) Appl. No.: 11/293,645

(22) Filed: Dec. 2, 2005

(30) Foreign Application Priority Data
Dec. 2, 2004 (CH) 01989/04

(51) Int. Cl. F16H 3/44

(52) U.S. Cl. 475/314

(57) ABSTRACT

A shiftable drive mechanism for bicycle or similar is proposed which includes a driveshaft and coupling supported at the driveshaft and movable in axial direction relative to the driveshaft and a first and second function element fro transmitting power to a housing and wherein the coupling with its two coupling members having a first function element with a recess formed as curved tracks, alternatively a second functional element with a recess formed as curved tracks such that upon a rotational movement about the longitudinal axis the at least two coupling members are sequentially and form fittingly engaging the curved tracks recesses.

### CROSS-REFERENCES TO RELATED APPLICATIONS

This application claims the priority of Swiss Patent Application Serial No. 01989/04, filed Dec. 2, 2004 pursuant to 35 U.S.C. 119(a)-(d), the subject matter of which is incorporated herein by reference.

### BACKGROUND OF THE INVENTION

The present invention relates to a shiftable drive mechanism and in particular to a shiftable drive mechanism suitable for a bicycle or the like which includes a housing supporting a hollow cylindrical driveshaft movable in axial direction and carrying at least one crank arm, wherein a clutch which is rotatable about the longitudinal axis and is movable in axial direction relative to the driveshaft by means of a shift rod co-axially supported in the driveshaft in order to realize a form-locking connection with power-transmitting function elements.

Shiftable drive assemblies for commercial bicycles are known wherein the gear shifting includes a hollow cylindrical driveshaft supported in a bottom bracket bearing gear housing, and a shifting shaft and a clutch member supported at the driveshaft and rotatable together with the driveshaft about the longitudinal axis and slidable in axial direction relative to the driveshaft by means of the shifting shaft to thereby realize an operational connection with force-transmitting function elements.

From printed publication DE-A 38 27 819, a bottom bracket bearing gear is known of the type wherein the shifting shaft is moveable in axial direction with the result that the clutch member is moved in axial direction and dependent on the direction of the movement can be operationally engaged relative to the driveshaft in from-fitting manner with either the sun wheel or the chain wheel which are each rotatable about the longitudinal axis, in order to change the rotational speed.

From EP-A 0 562 470, a bottom bracket bearing gear is known, wherein in order to provide force transmission, the sun wheel which is rotatable about the longitudinal axis of the driveshaft and the chain wheel, are each provided with a plurality of stepped recesses circumferentially spaced relative to each other and wherein the clutch member which is axially movable relative to the driveshaft in dependence upon the direction of the movement, is either operationally engaged in a form-fitting manner with the sun wheel or with the chain wheel.

From U.S. Pat. No. A-5,609,071, another bottom bracket bearing gear is known wherein the clutch member is provided on both sides with a locking device which comprise a plurality of locking elements in circumferentially spaced relationship with the sun wheel rotatable about the longitudinal axis of the driveshaft and the chain wheel at the side facing the clutch member is provided with similar locking device and wherein the locking elements facing each other are form-fittingly mutually engaged in dependence upon the direction of the movement of the clutch member.

In publication WO 98/29296, a bottom bracket bearing gear is disclosed which comprises force transmitting elements disposed on one end of the shift shaft and in operational connection with the first clutch member and the shift shaft and which comprises on the other end of the shift shaft a second clutch member which is operationally engaged by means of a control body, as well as an actuating member which is disposed at the bottom bracket bearing gear housing and rotatable about the longitudinal axis of the housing in such a way, that in dependence of the rotational movement of the actuating member, the shifting shaft as well as the force transmitting elements are movable in axial direction to realize a change in rotational speed.

These afore-described mechanisms suffer from certain drawbacks which the present invention has tried to resolve. It would therefore be desirable and advantageous to provide an improved drive mechanism to obviate prior art shortcomings and to provide a more suitable mechanism to realize this object.

### SUMMARY OF THE INVENTION

In one aspect of the invention a shiftable drive mechanism is provided by means of which the engagement of the individual function elements necessary for the change in rotational speed is facilitated in a precise switching operation and secure handling.

In another aspect of the present invention a shiftable drive mechanism for a bicycle includes a housing, a hollow-cylindrical driveshaft received in the housing and operatively connected with at least one crank arm, a shift rod disposed coaxially in the driveshaft and movable in an axial direction in relation to the driveshaft, and a rotatable clutch supported by the driveshaft and jointly moving with the driveshaft about a common length axis, said clutch being movable by the shift rod in axial direction relative to the driveshaft for realizing a formfitting connection with force-transmitting function elements, said clutch including at least two clutch members in circumferentially spaced-apart relationship, each clutch member including first and second locking elements disposed in parallel relationship to the driveshaft and movable relative to one another, wherein the clutch members are constructed to move in dependence on an axial movement of the clutch and in response to a rotation of the driveshaft and the clutch about the length axis such that at least two of the first locking elements form-fittingly engage a recess in one of the function elements or at least two of the second locking elements formfittingly engage a recess in the other one of the function elements in successive manner for transmitting a driving force onto the housing.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal section of a first embodiment of a drive mechanism for a bicycle or similar disposed in a housing according to the present invention;

FIG. 2 is a section of the embodiment in FIG. 1 along line II-II showing a planet carrier for the drive mechanism with a first curved track in a front view;

FIG. 3 is a section according to line III-III of FIG. 1 with a flange disposed in the housing provided with a second curved track for the drive mechanism;

FIG. 4 is a variation of the planet carrier according to FIG. 2 showing a plurality of first curved tracks in circumferential and spaced-apart relationship to each other;

FIG. 5 is a variation of the flange according to FIG. 3, showing a plurality of second curved tracks in circumferential and spaced-apart relationship to each other;

FIG. 6 is a longitudinal section of a second embodiment of the drive mechanism partially shown in a frontal view;

FIG. 7 is a longitudinal section of a third embodiment of the drive mechanism;

FIG. 8 is a longitudinal section of a forth embodiment of the drive mechanism;

FIG. 9 is an enlarged view of a longitudinal section of a variation of the driveshaft for the drive mechanism;

FIG. 10 a partial portion of the driveshaft according to FIG. 9 with the co-axially disposed shift rod in a first position;

FIG. 11 the partial portion of the driveshaft according to FIG. 10 showing the shift rod in a second position; and

FIG. 12 a sectional view of the gear shift knob for the shift rod of FIG. 9.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

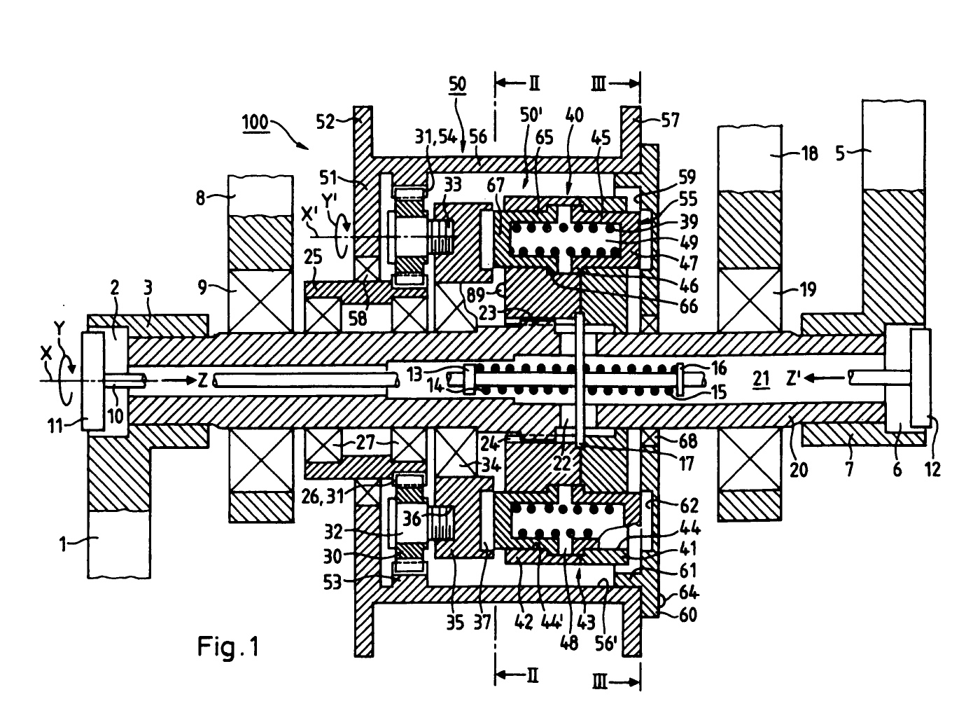

Turning now to the drawing, and in particular to FIG. 1, there is shown the section of a drive mechanism for a bicycle (not shown here in detail), and for powering at least one wheel of a cycle, in particular also a cycle that is configured as a high-wheeler or a unicycle, or also as a so-called reclining bicycle, where in all cases, the driving power is transmitted without any auxiliary means to the driven wheel by a drive mechanism disposed in a suitable housing. In another variation, a chain wheel is disposed at the housing by means of which the driving power is transmitted via a chain to the driven wheel.

FIG. 1 shows a first embodiment of the drive mechanism 100 which includes a housing 50 configured as wheel hub. Disposed in the housing 50 are a driveshaft 20 and the function elements associated therewith, which are further described in detail herein.

Seen in FIG. 1 is a schematic representation of spars 8 and 18 of a bicycle fork or the portion of a bicycle frame not shown in detail here, and which are disposed, one on each side, on the driveshaft 20. The two spars 8 and 18 are supported at the driveshaft 20 by means of roller bearings 9 and 19. At each end of the hollow-cylindrical driveshaft 20, a crank arm 1 and 5 provided with a bearing sleeve 3 and 7 is mounted in operative connection (not shown here in detail) with the driveshaft. The function elements of the drive mechanism 100 which are in operative association with the driveshaft 20 are supported in the interior space 50′ of the housing 50 and are rotatable about the longitudinal axis X of the driveshaft 20 in the direction of arrow Y by means of the crank arms 1 and 5.

Driveshaft 20 has an axial passage 21 in which a shift rod 10 is co-axially disposed for axial movement in the direction of arrow Z or Z′. At each end of the shift rod 10 is a gear shift knob which are each secured in a recess 2 and 6 of crank arms 1 and 5 by means of a screw connection. In addition, a driving pin 17 is disposed at the shift rod 10 with a pressure spring 14 and 15 disposed at each side of the driving pin 17. The restoring force of each of the pressure springs 14 and 15, respectively disposed at each end of the driving pin 17, is controlled by control members 13 and 16 which are disposed at the shift rod 10 so they can each be either secured in place or moved. The driving pin 17 is guided in a recess 22 of driveshaft 20 which is slotted in axial direction by means of radially outwardly oriented section parts. The driving pin 17 is also operatively connected with a clutch 40 which is disposed at the driveshaft 20 and movable in axial direction.

The first embodiment as depicted in FIG. 1 shows a drive mechanism 100 which includes the housing 50 and the driveshaft 20 co-axially disposed in the housing 50, a sun wheel 25, a planet carrier 35 and planet wheels 30 supported thereon and a clutch 40 which is operatively connected to the driveshaft 20 and axially movable relative thereto. Sun wheel 25 and planet carrier 35 are supported at driveshaft 20 respectively, via roller bearings 27 that are in axially spaced relationship and via roller bearings 34. The driveshaft 20 and clutch 40 movable relative to the driveshaft are in operative connection, for example via toothing. To realize this connection, the driveshaft 20 is provided with an outer toothing 23 and the clutch 40 is provided with an inner toothing 24.

Housing 50 in FIG. 1 is, for example, configured as a wheel hub having a first side wall 51, which is supported at the sun wheel 25 via a roller bearing 58 and is provided at one end with an outer ring 52. Disposed at this first side wall 51 is an axially oriented cylindrical hollow housing part 56, which extends into a radially outwardly oriented ring flange 57. Parts 51, 52, 56 and 57 together form the unit of housing 50 having an interior space 50′. At the end opposite the first side wall, housing 50 is closed with end flange 60.

When using the housing 50 as a wheel hub, the two rings 52 and 57 that are spaced parallel from each other are provided circumferentially with a plurality of bore holes (not shown). The bore holes serve to secure the spokes (not shown) for the driven wheel. In a further variation not shown here, at least one of the rings 52, 57 laterally disposed at the housing 50 are configured as a chain wheel which is provided in known manner with an outer toothing (not shown here).

The end flange 60 is supported at the driveshaft 20 by means of a roller bearing 68 and centered in the cylindrical interior 56′ of housing part 56 by means of a circular extension portion 61 formed at the end flange 60. The end flange 60 is, for example, secured to the housing 50 by means of circumferentially spaced screws 64. At least one recess 62 is disposed at the inner side 59 of the end flange 60. This recess is configured as a curved track and configured for engaging with at least two clutch members which are disposed at the clutch in axis-parallel manner relative to the driveshaft 20. Upon rotation of the clutch 40 around the longitudinal axis, clutch members 55 are sequentially engaging in recess 62. The configuration of the recess 62 and variations thereof are described in connection wit the FIGS. 3 and 5.

As shown in FIG. 1, at least one planet wheel 30, preferably several planet wheels spaced in circumferential disposition are supported by a planet carrier 35 that is supported by roller bearings 34 at the driveshaft 20. Planet wheel 30 is supported at a bearing neck 32 and rotatable about axis X′ of the bearing neck in direction of arrow Y′. The bearing neck 32 is for example pressed into a bore 36, or it is screwed into planet carrier 35 via a threaded bore 36 of the planet carrier 35 by means of a threaded piece 33. Each single planet wheel 30 is provided with an outer toothing 31 which is in operative engagement with an outer toothing 26 of the sun wheel and with an inner toothing 54 disposed at the interior side 56′ of housing part 56. In the example shown in FIG. 1, a ring 53 provided with an inner toothing is disposed at the interior side 56′ of the cylindrical housing part 56.

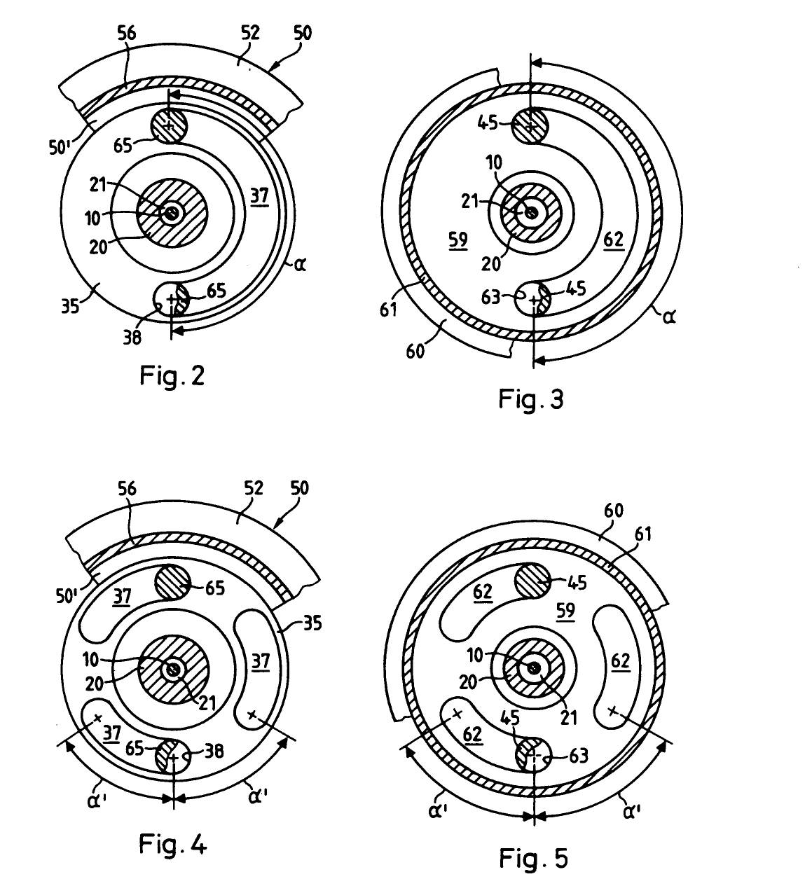

The side wall of the planet carrier 35 facing the clutch 40 is provided with a recess 37. Upon rotation of the clutch about the longitudinal axis, the clutch members 55 which are part of the clutch 40 sequentially engaging the recess 37. The configuration of the recess 37 in planet carrier 35 and other variations are further described in connection with FIGS. 2 and 4.

Clutch 40 as shown in FIG. 1 is divided into two clutch portions 41 and 42 along a partitioning line 43 extending orthogonally with respect to the driveshaft 20. The two clutch portions 41 and 42 are substantially disk shaped and provided with bores 44 and 44′ that are circumferentially spaced and connected with each other. Received in bore 44 of part 41 is a first locking element 45 and in bore 44′ of the other part 42 is received a second locking element 65. The single clutch member 55 which is in axis-parallel disposition relative to the driveshaft 20 comprises both locking elements 45 and 65. The parts 41 and 42 adjacent to clutch member 55 are substantially circular disk shaped, and as part of the clutch 40, are connected to each other for example by means of circumferentially spaced screws 89 or similar means. The clutch portions 41 and 42 with the adjacent clutch members 55 form a unit.

The two locking elements 45 and 65 each are of hollow cylindrical shape and each provided with a circular bearing collar 46 and 66 and together with front walls 47 and 67 facing the circular collars 46 and 66, form a discrete interior space 49. A spring 39 disposed inside space 49 bears at the interior side walls of front walls 47, 67. Through the restoring force of the spring 39, the collar 46 and 66 of the two stops 45, 65 are pressed against an edge (not further identified) of bores 44 and 44′.

The position of the drive mechanism 100 as depicted in FIG. 1 shows that the two locking elements 45 and 65 of clutch member 55, due to the restoring force of the spring 39 are spaced from each other by a slot 48. The width dimension of slot 48 between the first and second collar 46 and 66 corresponds approximately to the depth dimension of the locking elements 45 and 65 in the recesses 37 or 62 of the respective function elements 35 or 60 which the locking elements 45 and 65 engage. Upon the occurrence of any malfunction, slot 48 ensures that should one of the locking elements of clutch member 55 be blocked, it will be pressed into the basic position by the other movable locking element.

Seen in FIG. 1 are the two locking elements 45 and 65 of clutch member 55 disposed on clutch 40, in “neutral position” where no power is transmitted. In order to transmit power, the clutch 40 is being moved in the direction of arrow Z or Z′ in axial direction relative to the driveshaft 20 by actuation of the shift rod 10 which is in operative connection with the driveshaft 20 and the driving pin 17. When shift rod 10 is moved in arrow direction X, the clutch 40 together with the two first locking elements 45 that are disposed diametrically to each other, is brought into engagement with the groove-shaped curved track 62 located at the interior side 59 of end flange 60. Upon the movement of the shift rod 10 in the arrow direction X′, the clutch 40 together with the second stops 65 that are disposed diametrically to each other is brought into engagement with the substantially groove-shaped curved track 37 of planet carrier 30.

The two clutch members 55 with first locking elements 65 (FIG. 2) and the second locking elements 45 (FIG. 3) are circumferentially spaced in a set-off relationship to each other at clutch 40 with an angle α of 180 degrees. In a variation of this embodiment and for a different balance of force, several clutch members 55 may be circumferentially spaced in set-off relationship to each other at clutch 40.

FIGS. 2 and 4 each represent a section according to line II-II in FIG. 1 showing in part the housing 50 with interior 50′ and the cylindrical housing part 56 and the flange 52. The driveshaft 20 is coaxially disposed in the interior 50′ with a passage 21 and the shift rod 10 disposed therein and the planet carrier 35 with the curved track 35. According to a variation as depicted in FIG. 4, for example three curved tracks that are extending in circumferential direction and spaced from each other are disposed at the planet carrier 35.

In the embodiment as shown in FIG. 2, the planet carrier 35 has curved track 37 formed as a semi-circle and extending in circumferential direction over an angle [symbol] of 180 degrees. An inner wall 38 borders the substantially groove shaped curved track 37 of planet carrier 35 at each end. Both interior walls 38 are configured as a semi-circle for bearing against the cylindrical and diametrically disposed second locking element 65.

In the embodiment shown in FIG. 4, the planet carrier 35 is provided with three circumferentially spaced curved tracks 37. The curved tracks are at each of their respective ends bordered by a semi-circular shaped inner wall 38 for bearing against the second locking elements 65. The three curved tracks 37 that are spaced-apart, each follow a circular arc-shaped form and are circumferentially extending over an angle α′ of 60 degrees.

FIGS. 3 and 5 each show the end flange 60 shown in frontal view according to line III-III in FIG. 1 where the circular centering ring 61 is shown and the curved track 62 which is disposed at inner side 59 and circumferentially orientated. Also shown is the drive shaft 20 and the shift rod 10 co-axially supported in the interior space 21 of the driveshaft 20.

In the embodiment as shown on FIG. 3, the end flange 60 is provided with curved track 62 which is of a substantially semi-circular shape and similar as curved track 37 (FIG. 2) extends over an angle α of 180 degrees. At each end, the curved track is bordered by an inner wall 63. Each of inner walls 63 is semi-circular shaped for bearing against the two first locking elements 45 of clutch 40 which are circumferentially disposed in a set-off arrangement.

In the embodiment as shown in FIG. 5, the end flange 60 is provided with three curved tracks 62 circumferentially spaced-apart. At each of their ends, the curved tracks 62 are bordered by a semi-circular inner wall 63 for bearing against the first locking members 45. Each of the three tracks are of semi-circular shape and extending in circumferential direction over an angle [symbol] ′ of 60 degrees.

In other possible embodiments, the planet carrier 30 and the end flange 60 are provided with two or more curved tracks 37 or 62 that are circumferentially arranged in symmetrical relationship to each other, for example, over an angle of 30 degrees or 45 degrees, or may be provided with a plurality of recesses configured as blind bores in circumferentially disposed and spaced-apart relationship for engaging with the locking elements 45 and 65 of clutch 40.

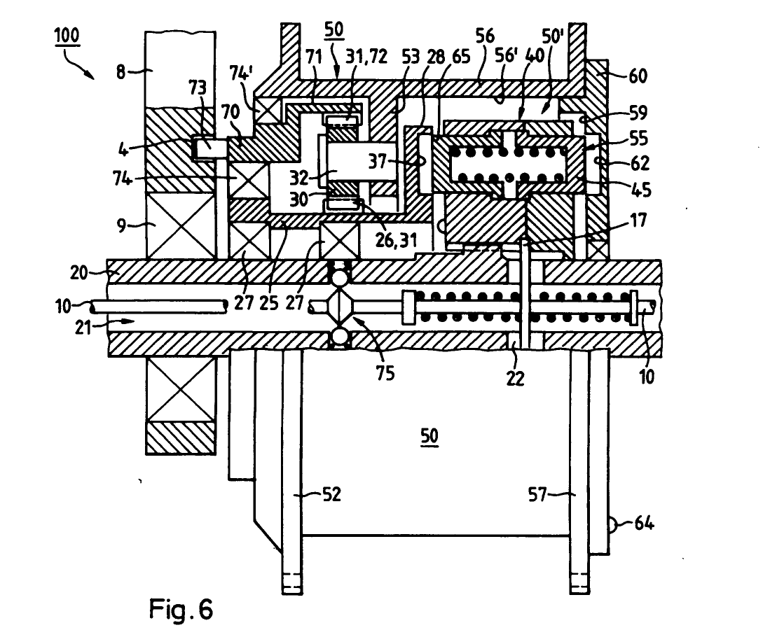

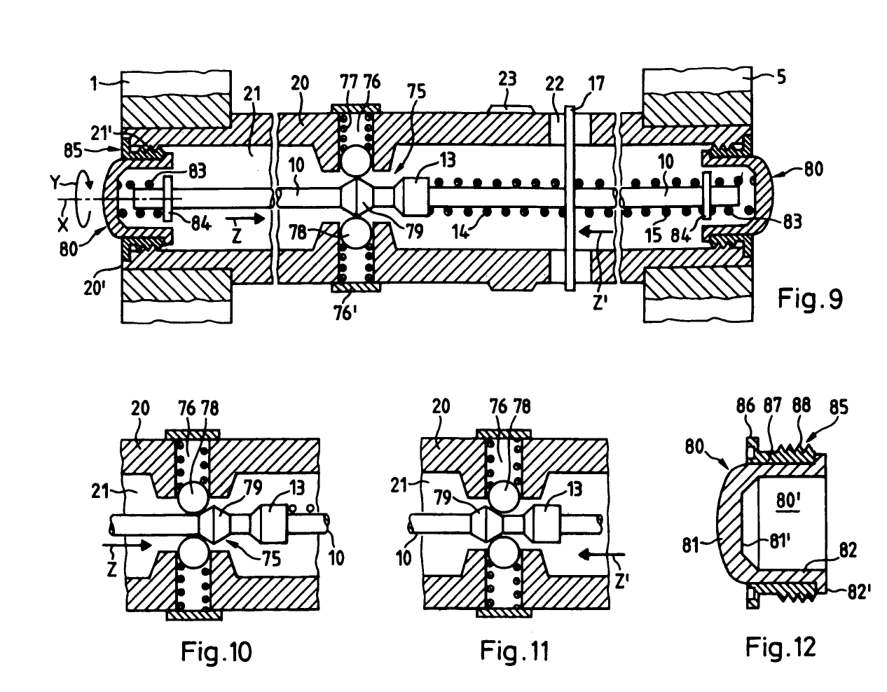

Further advantageous embodiments of the drive mechanism 100 are illustrated by means of FIGS. 6 and 8, wherein the non-designated parts are identical with those parts as shown and designated in FIG. 1. A locking mechanism 75 as schematically illustrated in FIG. 6 to 8 will be further described through FIGS. 9 to 11.

A second embodiment is depicted in FIG. 6 as a longitudinal section of the drive mechanism 100, partially shown in front view. The drive mechanism 100 includes the driveshaft 20 with the shifting rod 10 co-axially supported within the passage 21 of the driveshaft 20, and the clutch 40 operatively connected to the driveshaft 20 showing the locking elements 45 and 65 of the clutch members 55, and the curved track 62 disposed at the inner side 59 of the end flange 60. The afore-described elements are substantially analog the elements 10, 20, 40, 55, 60 of drive mechanism 100 as shown in FIG. 1. The sun wheel 25 and the housing 50 which differ from the first embodiment of FIG. 1 as well as an additional part, intermediate part 70, are described in the following paragraphs.

The housing 50 as illustrated in the embodiment of FIG. 6 is supported at one end by intermediate member 70 via a roller bearing 74′. The housing 50 includes the cylindrical housing part 56 with the two circular flanges 52 and 57 disposed therein in axial and spaced apart relationship, and the ring 53 disposed at the inner side 56′ of the housing part 56. A plurality of bearing necks 32 for supporting each of the planet wheels 30 is circumferentially disposed. The bearing necks 32 are secured to the ring 53 via a threaded connection or a press-fit connection.

The sun wheel 25 having an outer toothing 26 and supported at the driveshaft 20 is provided at the end facing the clutch 40, with an integrally formed circular disk 28. At the side facing the clutch 40, the disk 28 is provided with a curved track in accordance with FIG. 2, or a plurality of curved tracks 37 in accordance with FIG. 4. At the inner side facing the clutch 40, the end flange 60 disposed at the housing 50 is provided with a curved track 62 in accordance with FIG. 3, or with a plurality of curved tracks in accordance with FIG. 5.

In accordance with FIG. 6, the intermediate member 70 is supported at sun wheel 25 via roller bearing 74 and has a cylindrically shaped portion 71 which projects in axial direction into the interior 50′ of housing 50. The portion 71 has an inner toothing 72 for operative engagement with the outer toothing 31 of planet wheels 30, which are disposed in circumferentially spaced-apart relationship and supported at ring 53. A pin 73 is secured at the front side of intermediate member 70. With its free end, the pin 73 is received in the blind bore recess provided at the cycle fork 8 in order to secure the intermediate member 70 at the cycle fork 8 against rotational movement.

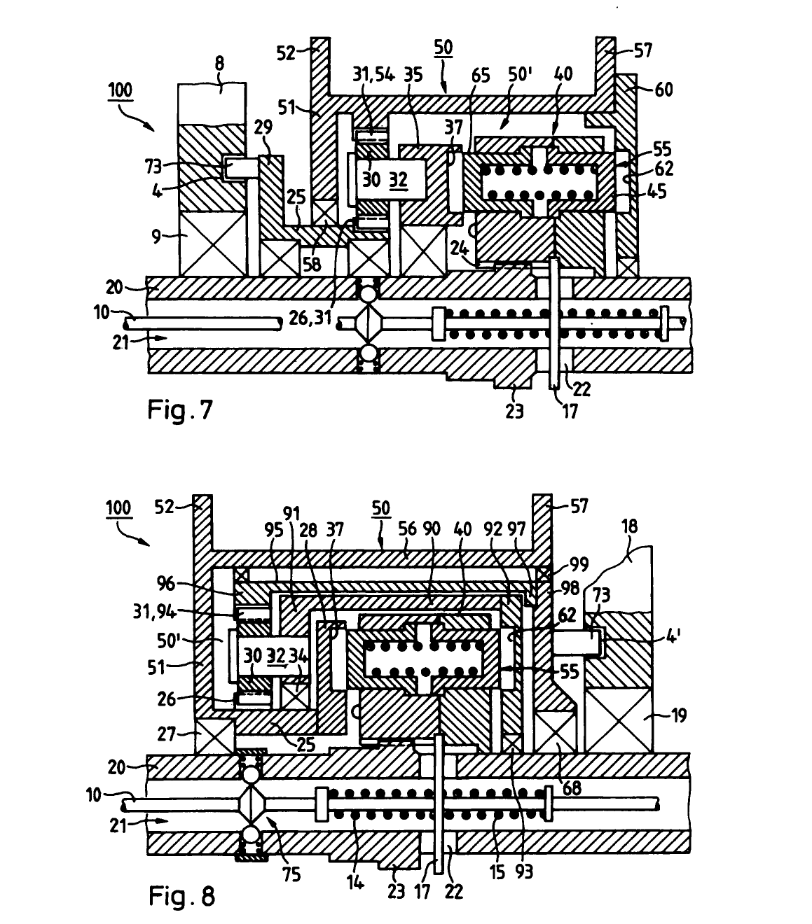

A third embodiment in FIG. 7 shows a sectional view of the drive mechanism 100, which is configured essentially as the drive mechanism of FIG. 1 with the housing 50, the drive shaft 20 with shifting rod 10 and the sun wheel 25 with outer toothing and supported at the driveshaft 20, and the clutch 40 operatively connected to the driveshaft comprising the two locking elements 45 and 65 of clutch member 55, the planet carrier 35 with the planet wheel 30 disposed at the bearing neck 32, and the end flange 60 disposed at housing 50. The curved track 37 (FIGS. 2, 4) and 65 (FIGS. 3, 5) are respectively shown for planet carrier 35 and end flange 60.

Differing from the second embodiment (FIG. 6), the third embodiment includes in accordance with FIG. 7, a sun wheel 25 with a circular disk 29. The disk 29, which is preferably unitary with sun wheel 25, is disposed between the side wall 51 of housing 50 and the cycle fork 8 in such a manner that the pin 73 attached to disk 29 engages with one end in a blind bore 4 of cycle for 8, thereby restricting the sun wheel 25 at the cycle fork 8.

FIG. 8 shows as a fourth embodiment, the longitudinal section of the drive mechanism 100 which includes the housing with the interior space 50′ with a fist and a second hollow cylindrical intermediate piece 90 and 95 disposed in interior space 50′. Also shown are the driveshaft 20 with shifting rod 10 and the clutch 40 which is in operative engagement with the driveshaft and the clutch member 55 with locking elements 45 and 65.

In accordance with FIG. 8, housing 50 is provided with the hollow cylindrical housing part 56 and the side wall 51 as well as the flanges 52 and 57 which are disposed on housing part 56. The sun wheel 25 with outer toothing 26 and supported at the driveshaft is supported at side wall 51 via roller bearing 27, The sun wheel 25 is configured as a cylindrical element and preferably integrally formed with the sidewall 51 of housing 50 such that the parts 25, 51, 52, 56 and 57 form a unit.

A disk 28 is disposed at the hollow-cylindrical member of sun wheel 25 and secured by means not shown her in detail, but for example, by a screw connection. At the side facing the clutch 40, disk 28 is provided with a curved track 37. At the end opposite the side wall 51 of housing 50, an approximately disk-shaped closing element 98 is supported at the driveshaft 20 via a roller bearing 68. With its hollow-cylindrical housing part 56, the housing 50 is supported at the second intermediate piece 90 and on end element 98 via two spaced-apart roller bearings 99.

The first intermediate piece 90 which is co-axially disposed in the interior 50′ of the housing 50 has formed thereon at one end a ring 91, and is supported by the sun wheel via the associated roller bearing 34. Ring 91 is provided with circumferentially disposed bearing necks 32, which are secured by means of a screw threaded or press-fit connection (not shown), for supporting each of the planet wheels 30. Disposed at the other end of the first intermediate piece 90 is a disk-shaped end flange 92. At the side facing the clutch 40, the end flange 92 is provided with curved track 62 and secured to the intermediate piece 90 by means of for example a plurality of circumferentially spaced screws (not shown). End flange 92 is supported at the driveshaft 20 via a roller bearing 93.

The second intermediate piece 95 which is co-axially disposed in the housing 50 has at one end formed thereon a ring 96 with inner toothing 94. Inner toothing 94 of ring 96 as well as the outer toothing 26 of sun wheel 25 are operatively connected via the toothing 31 of each of the planet wheel 30. The planet wheels 30 are circumferentially disposed in spaced-apart relationship and supported at the ring 91 of the first intermediate piece 90. The second intermediate piece 95 is supported at the end flange 98 by means a shoulder which is integrally formed with the other end of the second intermediate piece 95.

FIG. 8 showing the fourth embodiment, the pin 73 is disposed and secured with one end at the end flange 98. The other end of the pin 73 is received in the blind bore 4′ of cycle fork 18 in such a way that the end flange 98 supported at the driveshaft 20 is held at cycle fork 18.

The clutch 40 in the drive mechanism 100 as shown in FIG. 1, is axially moved relative to the driveshaft 20 and brought into operative engagement with either the planet carrier 35 or the end flange 60, wherein the clutch members 55 circumferentially spaced at the clutch 40 are form-fittingly received either in the recess 37 of the planet carrier or with at least one recess 62 provided at end flange 60. In this particular embodiment, the driving power oriented about the length axis X of the driveshaft 20 in dependence on the position of clutch 40, is transmitted either through each of the planet wheels 30 supported by planet carrier 35 via the inner toothing 54 to the housing 50, or through the end flange 60.

In the drive mechanism 100 according to FIG. 6, the axially movable clutch 40 is brought into operative engagement with either the sun wheel 25 or end flange 60 such that the clutch members 55 circumferentially spaced at the clutch 40 are form-fittingly received either in the recess 37 of the disk 28, or with the at least one recess 62 provided at end flange 60. The driving power in this embodiment is, in dependence of the position of clutch 40, directly transmitted from end flange 60 to the housing 50. To realize this “gearing down” the driving power of the sun wheel 25 is transmitted to the housing 50, wherein the sun wheel 25 with its outer toothing 26 is operatively connected via a plurality of the inner toothing 72 of the stationary intermediate member 70 with outer toothing 31 of each of the planet wheels 30.

In the drive mechanism according to FIG. 7, the axially movable clutch 40 is brought into operative engagement with either the end flange 60 or with the planet carrier 35 such that the clutch members 55, circumferentially spaced at the clutch 40, are form-fittingly received either in the recess 62 provided at end flange 60, or in the at least one recess 37 of planet carrier 35. The driving power in this embodiment is, in dependence of the position of clutch 40, directly transmitted from end flange 60 to the housing 50. To realize a “first gear” the driving power of the sun wheel 25 is transmitted to the housing 50, wherein the stationary sun wheel 25 with its outer toothing 26 is operatively connected to the outer toothing 31 of planet wheels 30.

In the drive mechanism according to FIG. 8, the axially movable clutch 40 is being brought into operative engagement with either the sun wheel 25 or with end flange 92, such that the clutch members 55 circumferentially spaced at the clutch 40, are form-fittingly received either in the recess 37 of disk 28 provided at sun wheel 25 or in the at least one recess 62 of end flange 92. The driving power in this embodiment is, in dependence of the position of clutch 40, directly transmitted to the housing 50 via disk 28 operatively connected to sun wheel 25. To realize a “second gear” the driving power of end flange 92 is transmitted to the housing 50 via the operatively connected planet carrier 90 and several planet wheels 30 supported by the planet carrier 90 and the sun wheel 25 which is co-operating with the inner toothing 94 of the hollow cylindrical intermediate piece 95 with he outer toothing 31 of the planet wheels 30.

FIG. 9 shows an enlarged view of a preferred embodiment of driveshaft 20 with the crank arms 1 and 5 supported at each end of the driveshaft 20 and by which the driveshaft 20 and the operatively connected and afore-described elements of the drive mechanism 100 are actuated according to arrow Y about the length axis X (FIG. 1). The shifting rod 10 co-axially supported within the drive shaft 20 and operatively connected via the locking mechanism 75, is axially movable according to arrows Z or Z′ by means of shift knobs 80 provided at each end of the driveshaft 20. FIG. 9 also shows the pin 17 disposed at the shifting rod 10 and guided in a recess 22 against the restoring force of the two pressure springs 14 and 15.

The locking mechanism 75 shown in FIG. 9 has a wedge shaped cam 79 with two conically tapered circular gliding surfaces and a diameter that is larger than the shifting rod 10 and disposed in spaced apart relationship to the locking member 13. In the area of the locking mechanism 75, the driveshaft 20 is provided with one, preferably with two or more bores 76 spaced opposite each other and perpendicular to the length axis of the driveshaft 20. In each bore 76 a ball 78 and a spring 77 are arranged and secured by a support ring 76′. When the shifting rod 10 moves in axial direction, the spring biased balls 78 glide either into one locking position according to FIG. 10 or another locking position according to FIG. 11.

The two shift knobs 80 are disposed and secured in the hollow cylindrical driveshaft 20 by means of a screw-in guide piece 85. Each shift knob 80 is movable against the restoring force of the pressure spring 83 relative to the shifting rod 10 in axial direction according to arrow Z respectively Z′. Upon pressing, the respective knob 80 is axially moved relative to the guide piece 85 and thereby brought into operative engagements with shifting rod 10. The restoring force of the pressure spring 83 is controlled each by means of locking member 84 disposed at the shifting rod 10.

In FIG. 9, the locking mechanism 75 is illustrate in a theoretical center position, wherein the two shifting knobs 80 opposite each other are being pressed in outward direction by means of the restoring force of the respective pressure spring 83 with respect to the front side 20′ of the driveshaft 20 and held at the guide piece 85 by means of a stop 82′.

In FIG. 12, the shift knob 80 is shown in an enlarged view showing the guide piece 85 for receiving the shifting knob 80. The guide piece 85 has hollow cylindrical sleeve 87 and is provided with a stop 86 and a thread 88. The thread 88 of guide piece 85 is screwed into the axial bore 21 provided with a co-operating inner thread of driveshaft 20. The shift knob 80 having an interior space 80′ includes a cylindrical piece 82 provided with a circular stop 82′ and a front side 81 configured approximately convex arc-shaped and integrally formed with the cylindrical piece 82. The inner wall 81′ of the front side 81 is configured as a support surface for the pressure spring 83 (FIG. 9).

The afore-described drive mechanism 100 is configured for all types of cycles where the driving power is transmitted from the driveshaft 20 via the drive mechanism disposed in the housing to a driven wheel.

While the invention has been illustrated and described as embodied in a bicycle, unicycle or the like, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A shiftable drive mechanism for a bicycle or the like, comprising:
a housing including force-transmitting function elements;
a hollow-cylindrical driveshaft received in the housing and operatively connected with at least one crank arm;
a shift rod disposed coaxially in the driveshaft and movable in an axial direction in relation to the driveshaft; and
a rotatable clutch supported by the driveshaft and jointly moving with the driveshaft about a common length axis, said clutch being movable by the shift rod in axial direction relative to the driveshaft for realizing a formfitting connection with the force-transmitting function elements, said clutch including at least two clutch members in circumferentially spaced-apart relationship, each clutch member including first and second locking elements disposed in parallel relationship to the driveshaft and movable relative to one another, wherein the clutch members are constructed to move in dependence on an axial movement of the clutch and in response to a rotation of the driveshaft and the clutch about the length axis such that at least two of the first locking elements, or at least two of the second locking elements successively engage a recess in a respective one of the function elements for transmitting a driving power onto the housing.

2. The drive mechanism of claim 1, wherein the clutch is provided with a plurality of circumferentially spaced bores for receiving the clutch members such that the first and second locking elements of each clutch member confront one another end-to-end and are separated by a slot, wherein the first and second locking elements are movable relative to one another in parallel relationship to the length axis of the driveshaft in dependence on a restoring force applied by a pressure spring.

3. The drive mechanism of claim 2, wherein the clutch is of circular disk shape and divided in two clutch portions separated from one another along a parting line extending orthogonal to the driveshaft to thereby define each of the bores in the form of two aligned bores for respectively receiving the first and second locking elements, said clutch portions and the accommodated first and second locking elements jointly defining a unitary structure, said clutch including circumferentially spaced-apart screw fasteners for connecting the clutch portions.

4. The drive mechanism of claim 2, wherein the first and second locking elements are constructed of hollow cylindrical configuration for receiving the pressure spring and have distal and proximal ends, said distal ends formed with an end wall and said proximal ends formed with a circular collar for restricting an axial movement of the first and second locking elements.

5. The drive mechanism of claim 1, wherein the clutch members extend in circumferential direction at an angular offset of 180°.

6. The drive mechanism of claim 1, wherein the clutch members extend in circumferential direction at an angular offset of 60°.

7. The drive mechanism of claim 1, wherein the recess is configured in the form of a semi-circular curved track and extending in circumferential direction about an angle of 180°.

8. The drive mechanism of claim 7, wherein the recess is configured in the form of arcuate curved tracks and extending in circumferential direction about an angle of 60°.

9. The drive mechanism of claim 1, wherein the recess is a curved track has one end provided with a semicircular interior wall to realize a precise bearing surface for the locking elements.

10. The drive mechanism of claim 1, wherein one of the force-transmitting function elements is constructed to form an end flange, and another one of the force-transmitting function elements is constructed in the form of a planet carrier, for respectively transmitting a driving force to the housing

11. The drive mechanism of claim 10, wherein the end flange is mounted to the housing, and the planet carrier includes at least two planet wheels disposed on the housing in circumferentially spaced-apart relationship, each planet wheel having a first outer toothing for cooperation with an inner toothing of a ring of the housing, and a second outer toothing for cooperation with a sun wheel supported on the driveshaft for rotation about the length axis.

12. The drive mechanism of claim 11, wherein the sun wheel is stationary so that the planet wheels are rotated jointly with the planet carrier relative to the sun wheel about the length axis of the driveshaft.

13. The drive mechanism of claim 12, wherein the sun wheel has one end provided with a disk disposed between the housing and a frame part and having at least one pin for securing the sun wheel to the frame part.

14. The drive mechanism of claim 1, wherein one of the force-transmitting function elements is constructed to form an end flange, and another one of the force-transmitting function elements is constructed in the form of a disk, for respectively transmitting a driving force to the housing, said disk forming part of a sun wheel mounted to the driveshaft.

15. The drive mechanism of claim 14, wherein the end flange is secured to the housing, and wherein the other functional element has planet wheels circumferentially spaced-apart and supported at a ring element disposed on the housing, said planet wheels having each an outer toothing for cooperation with an outer toothing of the sun wheel, and an inner toothing of an intermediate member supported on the sun wheel and mounted to a frame part.

16. The drive mechanism of claim 15, wherein the housing has one end supported on the end flange and another end supported on the intermediate member, the intermediate member being secured by at least one pin to the frame part such that the planet wheels are rotatable jointly with the housing in relation to the intermediate member on the drive shaft about the length axis.

17. The drive mechanism of claim 1, wherein one of the force-transmitting function elements is constructed to form a first end flange, and another one of the force-transmitting function elements includes a sun wheel for cooperation with circumferentially spaced-apart planet wheels, for respectively transmitting a driving force to the housing, wherein the housing has one end supported by the driveshaft and another end supported by a second end flange.

18. The drive mechanism of claim 17, wherein the first end flange is secured to one end of a hollow cylindrical planet carrier whose other end is formed with a wall supported by the sun wheel for support of the planet wheels, the planet wheels having each an outer toothing for cooperation with an outer toothing of the sun wheel, and an inner toothing of a hollow cylindrical intermediate member secured to the second end flange.

19. The drive mechanism of claim 18, wherein the housing and the sun wheel form a unitary structure having one end supported on the hollow cylindrical intermediate member, and another end supported on the second end flange, wherein the intermediate member and the second end flange are secured by a pin of the second end flange to a frame part such that the sun wheel rotates jointly with the housing in relation to the intermediate member and the second end flange on the driveshaft about the length axis.

20. The drive mechanism of claim 1, wherein the driveshaft has opposite ends, each end having a bore for threadably receiving a guide piece carrying shift knobs which are movable in axial direction in relation to the shift rod interacting with a locking mechanism, for respectively initiating a shifting operation in opposition to a restoring force of an associated compression spring, and returnable after the shifting operation by the restoring force of the compression spring.
